(19) United States
(12) Patent Application Publication
(10) Pub. No.: US 2026/0116716 A1
(43) Pub. Date: Apr. 30, 2026

(54) TRACK JACK

(71) Applicant: Andrew W. Dow, Fort Edward, NY (US)

(72) Inventor: Andrew W. Dow, Fort Edward, NY (US)

(21) Appl. No.: 18/934,071

(22) Filed: Oct. 31, 2024

(51) Int. Cl. B66F 5/04

(52) U.S. Cl. CPC B66F 5/04

(57) ABSTRACT

A mobile hydraulic jack with a track assembly on either side that has first and second side plates with a plurality of rollers between them. The first and second side plates each have a plurality of cylindrical apertures, and each roller has a central cylindrical aperture. In each track assembly the cylindrical apertures in the first and second side plates and the central cylindrical apertures in the rollers are aligned to form a continuous aperture, and a plurality of retaining pins are inserted through each continuous aperture. A continuous belt surrounds the rollers to facilitate movement of the hydraulic jack along a surface.

### BACKGROUND

The present application relates generally to a hydraulic jack, and in particular to a mobile hydraulic jack that may be used to elevate at least a portion of a vehicle to provide or improve access for repair or maintenance work.

Such hydraulic jacks may be moved from place to place in a variety of environments, including internal environments such as garages having a rigid floor such as one made from concrete, and external environments where the surface may be rigid or semi-rigid, such as concrete, asphalt, gravel, brick, stone, or ground. A hydraulic jack may be moved, for example, from a storage location to a work location; between work locations; and from a work location to a storage location.

### BRIEF DESCRIPTION OF DRAWINGS

FIG. 1 is a side perspective view of a hydraulic assembly portion of a hydraulic jack.

FIG. 2 is a view of a handle assembly for a hydraulic jack.

FIG. 3 is a view of a handle gear assembly for a hydraulic jack.

FIG. 4 is a view of a torsion spring for a hydraulic jack.

FIG. 5 is a view of a lifting arm assembly of a hydraulic jack.

FIG. 6 is a view of a frame assembly of a hydraulic jack, including a track assembly.

FIG. 6A is detail A from FIG. 6, showing a wheel or roller of a hydraulic jack.

FIG. 7 is an exploded view of a track assembly of the present disclosure.

FIGS. 8A and 8B are views of retaining pins.

FIG. 9A is a view of a one type of retaining clip.

FIG. 9B is a view of another type of retaining clip also known as a cotter pin.

FIG. 9C is a view of a retaining pin with inserted cotter pin.

FIG. 9D is a view of a retaining pin with inserted retaining clip.

FIG. 9E is a view of a spring-type retainer.

FIG. 10 is an exploded view of a track assembly of the present disclosure.

### SUMMARY

The present application is directed to a hydraulic jack with a frame having a first side, a second side, a front end, a back end, a width, and a length. The hydraulic jack includes a lifting arm, hydraulic pump, and handle, and a first track assembly attached to the first side as well as a second track assembly attached to the second side.

The first and second track assemblies may each extend along substantially the entire length of the hydraulic jack frame, and include a first side plate adjacent the frame having a first plurality of apertures spaced horizontally along its length; a second side plate opposite the first side plate having a second plurality of apertures spaced horizontally along its length; and a plurality of rollers spaced along the track assembly between the first side plate and the second side plate, with each of the plurality of rollers having a central cylindrical aperture. The first track assembly and the second track assembly may be interchangeable.

Each of (a) the first plurality of apertures along the first side plate, (b) the central cylindrical aperture in each of the plurality of rollers, and (c) the second plurality of apertures along the second side plate are aligned to form a continuous aperture that extends through the first side plate, each of the plurality of rollers, and the second side plate.

A plurality of retaining pins may be inserted through each continuous aperture. Each retaining pin has a first end with a larger diameter than at least one of the plurality of apertures, and a second end having a circumferential groove or aperture to receive a retaining clip to retain the retaining pin within the continuous aperture.

The plurality of rollers may extend along substantially the entire length of the first side plate and the second side plate, with the tops of all rollers being coplanar.

Each track assembly may have a length that is approximately equal to the length of the frame; each of the plurality of rollers may have a diameter of between about 2 inches and about 3 inches; and at least one of the plurality of rollers may have a diameter of between about 2.25 inches and about 2.75 inches.

The roller in the first track assembly and in the second track assembly that is closest to the front end of the frame may have a diameter that is between about 5% and about 15% smaller than the diameter of the other rollers in the track assembly. For example, the roller in the first track assembly and in the second track assembly that is closest to the front end of the frame may have a diameter of about 2.5 inches, with the other rollers in the track assembly each having a diameter of about 2.75 inches.

In another embodiment the present application is directed to a hydraulic jack that includes a frame having a first side, a second side, a front end, a back end, a width, and a length. The hydraulic jack may further include a lifting arm, a hydraulic pump, a handle, a first track assembly attached to the first side, and a second track assembly attached to the second side. Each of the first track assembly and the second track assembly extend along substantially the entire length of the frame and include a first side plate adjacent the frame having a first plurality of apertures spaced horizontally along its length, a second side plate opposite the first side plate having a second plurality of apertures spaced horizontally along its length, and a plurality of rollers spaced along the track assembly between the first side plate and the second side plate, with each of the plurality of rollers having the same diameter and having a central cylindrical aperture.

Each of the first plurality of apertures along the first side plate, each the central cylindrical aperture in each of the plurality of rollers, and each of the second plurality of apertures along the second side plate, are aligned to form a continuous aperture extending through the first side plate, each of the plurality of rollers, and the second side plate. A plurality of retaining pins may be inserted through each continuous aperture, with each retaining pin having a first end that is larger in diameter than at least one of the first plurality of apertures and the second plurality of apertures, and a and a second end having a circumferential groove or aperture to receive a retaining clip to retain the retaining pin within the continuous aperture.

A first continuous belt may surround the plurality of rollers in the first track assembly and a second continuous belt may surround the plurality of rollers in the second track assembly. Each continuous belt may be made of a material including at least one of a fluoropolymer, an acetal polyoxymethylene resin, and a rubber. For example, each continuous belt may be made of a material including a fluoropolymer and an acetal polyoxymethylene resin. The fluoropolymer may be, for example, a polytetrafluoroethylene.

In another embodiment, the present application is directed to a track assembly for a hydraulic jack having a frame with a first side, a second side, and a length. The track assembly includes a first side plate which has a first plurality of apertures spaced horizontally along its length, a second side plate which has a second plurality of apertures spaced horizontally along its length, and a plurality of rollers that are spaced along the track assembly between the first side plate and the second side plate. Each of the plurality of rollers may have the same diameter and a central cylindrical aperture, and the tops of all rollers may be coplanar.

Each of the first plurality of apertures along the first side plate of the track assembly, each the central cylindrical apertures in each of the plurality of rollers, and each of the second plurality of apertures along the second side plate of the track assembly, are aligned to form a continuous aperture that extends through the first side plate, each of the plurality of rollers, and the second side plate.

A plurality of retaining pins may be inserted through each continuous aperture, with each retaining pin having a first end that is larger in diameter than at least one of the first plurality of apertures and the second plurality of apertures, and a second end having a circumferential groove or aperture to receive a retaining clip to retain the retaining pin within the continuous aperture.

One of the plurality of rollers of the track assembly that is not positioned between two other rollers has a diameter between about 5% and about 15% smaller than the diameter of the other rollers. For example, the roller having a diameter between about 5% and 15% smaller than the diameter of the other rollers in the track assembly may have a diameter of between about 2.25 inches and about 2.75 inches.

The present track assembly may include a continuous belt that surrounds the plurality of rollers in the track assembly. The continuous belt may be made of a material including at least one of a fluoropolymer, an acetal polyoxymethylene resin, and a rubber. For example, the continuous belt may be made of a material including a fluoropolymer and an acetal polyoxymethylene resin. The fluoropolymer may be, for example, a polytetrafluoroethylene.

### DETAILED DESCRIPTION

The hydraulic jack of the present application has a central frame to which components such as a lifting arm, hydraulic pump, and handle are attached. On each side of the central frame is a track assembly that has first and second side plates with a plurality of rollers between them that are surrounded by a continuous belt. The first and second side plates each have a plurality of cylindrical apertures, and each roller has a central cylindrical aperture. In each track assembly the cylindrical apertures in the first and second side plates and the central cylindrical apertures in the rollers are aligned to form a continuous aperture that extends through the first side plate, the rollers, and the second side plate. and a plurality of retaining pins are inserted through each continuous aperture to align the rollers and retain them between the first and second side plates.

When the present hydraulic jack is moved from one location to another location the continuous belt functions similarly to a tread. As the hydraulic jack is moved either forwards or backwards, the friction between the continuous belt and the surface the track is on will cause the belt to move over the rollers.

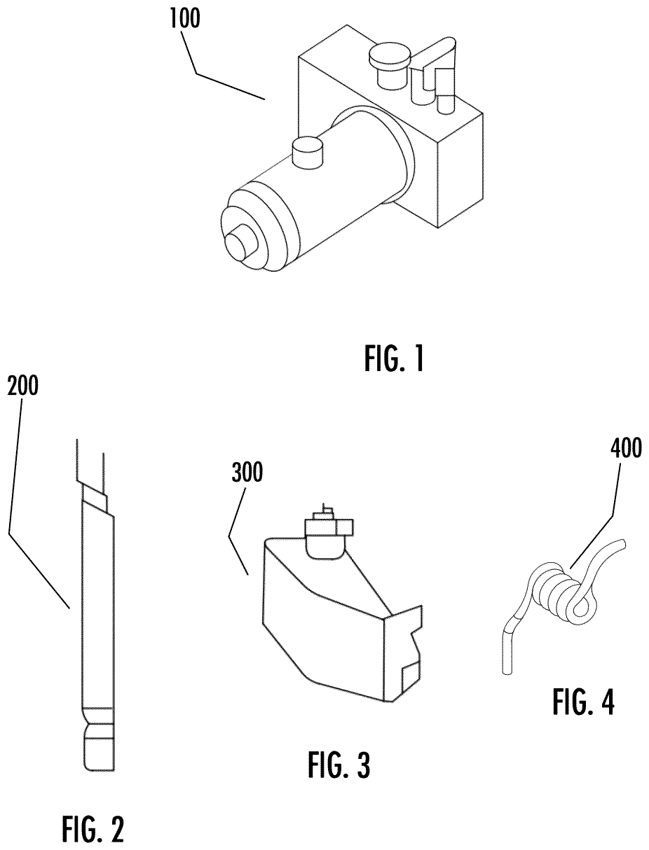

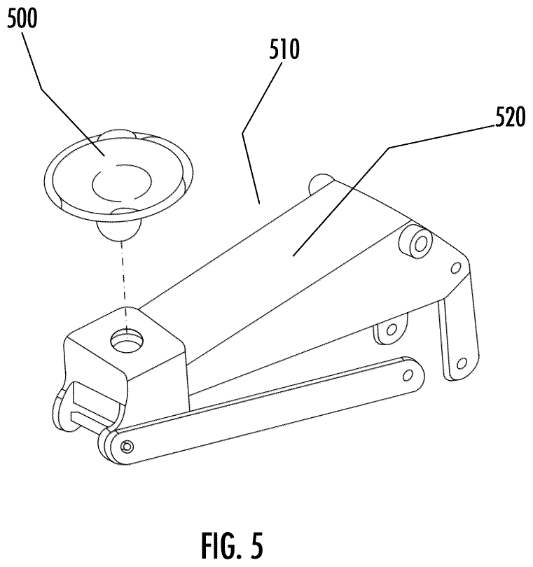

With respect to the parts of a hydraulic jack, FIG. 1 shows what may be variously referred to as power unit assembly or hydraulic assembly 100, which may include a safety valve assembly, pump piston, oil fill plug, and/or ram. FIGS. 2 and 3 show, respectively, handle 200 and handle gear assembly 300 that may engage with power unit assembly 100 and be used by an operator to raise or lower a lifting arm of the hydraulic jack. FIG. 4 shows torsion spring 400 that may engage handle 200 to bias it towards a default or resting position. FIG. 5 shows lifting arm assembly 510 with saddle 500 and lifting arm 520.

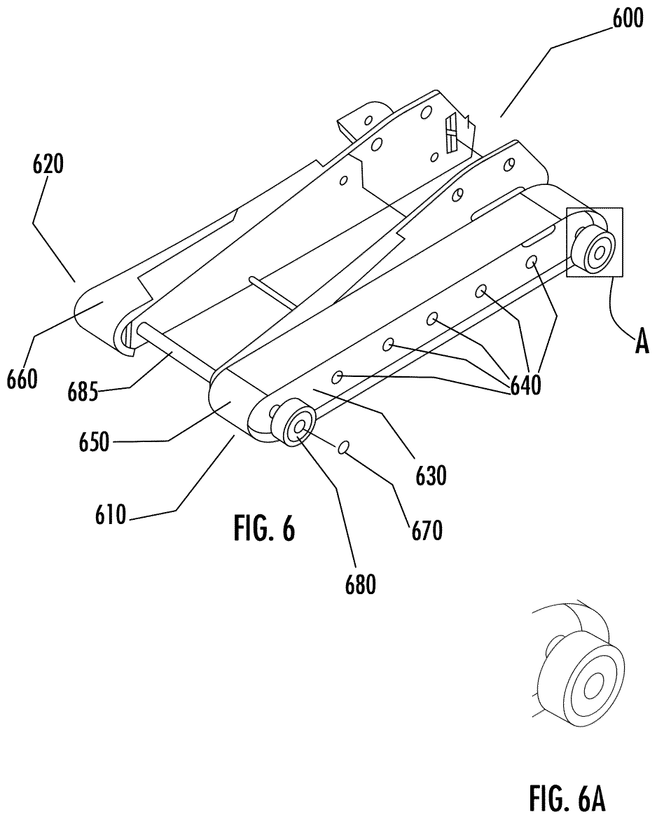

FIG. 6 shows a hydraulic jack of the present invention having frame assembly 600. First track assembly 610 is attached to a first side of frame assembly 600, and second track assembly 620 is attached to a second side of frame assembly 600. First track assembly 610 and second track assembly 620 have essentially the same construction except that, as will be readily appreciated, they are left side/right side mirror images of each other.

Taking for example first track assembly 610, it includes a first, inner side plate adjacent to the portion of frame assembly 600 that is between first track assembly 610 and second track assembly 620, and second, outer side plate 630. The inner side plate is not visible in FIG. 6 but is identical to outer side plate 630.

Outer side plate 630 has a plurality of apertures 640 spaced horizontally along its length, and the inner side plate has a corresponding plurality of apertures.

First track assembly 610 includes a plurality of rollers. The configuration in FIG. 6 shows first end roller 680 located on the outside of first track assembly 610 with a similar, second end roller also located on the outside of first track assembly 610 at the position indicated by detail A and as shown in FIG. 6A, with a plurality of intermediate rollers (not visible in FIG. 6, see FIG. 7 for reference). Either or both of the end rollers may alternatively be located between the side plates like the intermediate rollers.

Each of apertures 640 is aligned with a corresponding roller located between the first, inner side plate and outer side plate 630, the corresponding rollers having central apertures aligned with apertures 640. First end roller 680 and the corresponding second end roller may be secured with retaining element 670, which may be, by way of non-limiting example, a nut, pin, or retaining ring or clip. The same arrangement of rollers and retaining elements is present with respect to second track assembly 620. Alternatively, the two end rollers may be secured by first axle pin 685 extending the width of the proximal end of frame assembly 600 and passing through, as applicable, the end roller, the outer side plate, the inner side plate, and the corresponding elements of second track assembly 620. A second axle pin, not visible in FIG. 6, may similarly extend through the distal end of frame assembly 600 and the corresponding components of first track assembly 610 and second track assembly 620.

First track assembly 610 is surrounded by continuous belt 650, and second track assembly 620 is surrounded by continuous belt 660. In use, when the present jack is moved, such as by being pulled or pushed by handle 200 or otherwise, this causes the continuous belt and rollers to rotate.

FIG. 7 shows the hydraulic jack of the present application with both end rollers, i.e., end roller 730, located between the side plates of track assembly 700, adjacent the intermediate rollers. A plurality of rollers 715 having central cylindrical apertures 715A is thus positioned between first side plate 710 and second side plate 720. First side plate 710 has a first plurality of apertures 710A, and second side plate 720 has a plurality of apertures 720A.

Each of the apertures in first side plate 710, rollers 715, and second side plate 720 is coaxially aligned to form a plurality of continuous apertures into which a plurality of retaining pins 725 may be placed. Each retaining pin 725 may include a first end 725A which is larger in diameter than the diameter of corresponding aperture 720A in second side plate 720, and a second end 725B adapted to retain the retaining pin in place when inserted through the second side plate, rollers, and first side plate. Second end 725B may have a hole extending along a diameter of the retaining pin, or a circumferential groove. The length of the retaining pin is sufficient so that, when the retaining pin is inserted through both side plates and the roller until first end 725A contacts the outer surface of second side plate 720, the portion of second end 725B in which the hole or circumferential groove is located extends beyond the outer surface of first side plate 710. This allows a retaining clip to be inserted through the hole or around the circumferential groove in order to hold the retaining pin in place.

As shown in FIG. 7 each of the two end rollers, such as end roller 730, is smaller in diameter than the intermediate rollers, generally from about 5% smaller to about 15% smaller, with the top of each end roller being coplanar with the tops of the intermediate rollers. This can facilitate movement of the hydraulic jack over an uneven surface, such as by enabling a ramp effect. For example, the intermediate rollers may each have a diameter of about 2.25 inches, and the two end rollers may then have diameters of between about 0.21375 inches (which is 5% smaller) and about 0.19125 inches (which is 15% smaller). Alternatively, the intermediate rollers may each have a diameter of about 2.75 inches, and the two end rollers may then have diameters of between about 0.26125 inches (which is 5% smaller) and about 0.23375 inches (which is 15% smaller). Diameters between about 2.25 inches and about 2.75 inches are also within the present scope; for example, the intermediate rollers may each have a diameter of about 2.5 inches, and the two end rollers may then have diameters of between about 0.2375 inches (which is 5% smaller) and about 0.2125 inches (which is 15% smaller).

Because the end rollers have a smaller diameter than the intermediate rollers and the top of each end roller is coplanar with the tops of the intermediate rollers, the central cylindrical aperture of each end roller will be higher than the central cylindrical apertures of the intermediate rollers. The apertures in first side plate 710 and second side plate 720 that correspond with the end rollers, such as central cylindrical aperture 735, will therefore likewise be higher than the side plate apertures that align with the intermediate rollers.

In addition to rollers 715 (and as indicated for FIG. 6), the track assembly may have first axle pin 740A and second axle pin 740B. While retaining pins 725 act to connect the side plates and rollers of one track assembly, the axle pins connect the first track assembly and second track assembly.

When assembled, continuous belt 705 surrounds and is in at least partial contact with at least one or more of rollers 715, being of a length selected such that sufficient tension is provided to create contact between the belt and the rollers when the hydraulic jack is being moved along a surface. The belt may also at least partially extend widthwise over the top, bottom, and sides of first side plate 710 and second side plate 720.

Continuous belt 705 may be made of any material having suitable properties of flexibility, durability, and friction for the described use of the present hydraulic jack. Suitable materials include but are not limited to at least one of a fluoropolymer, an acetal polyoxymethylene resin, and a rubber. In one embodiment the continuous belt may be made of a material comprising a fluoropolymer and an acetal polyoxymethylene resin. In a further embodiment the continuous belt may made of a material comprising a polytetrafluoroethylene and an acetal polyoxymethylene resin.

When the present hydraulic jack is assembled so that the respective apertures in the first side plate, each of the plurality of rollers, and the second side plate are aligned to form a series of continuous apertures, each retaining pin is inserted through one such continuous aperture, starting with the end opposite the enlarged head. Each retaining pin has a length sufficient for the end opposite the enlarged head to extend beyond the second side plate to an extent that provides access to the aperture or groove provided in that end. The enlarged head at the other end of the retaining pin will prevent it from passing through the aperture in the side plate, and a retaining pin or clip, as applicable, may be applied to the aperture, groove, or similar feature at the other end of the retaining pin to secure it in place.

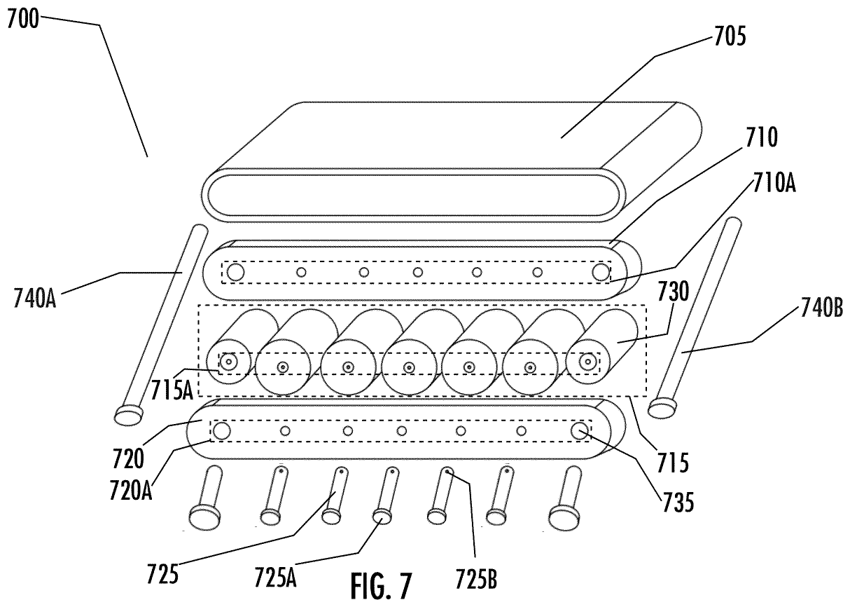

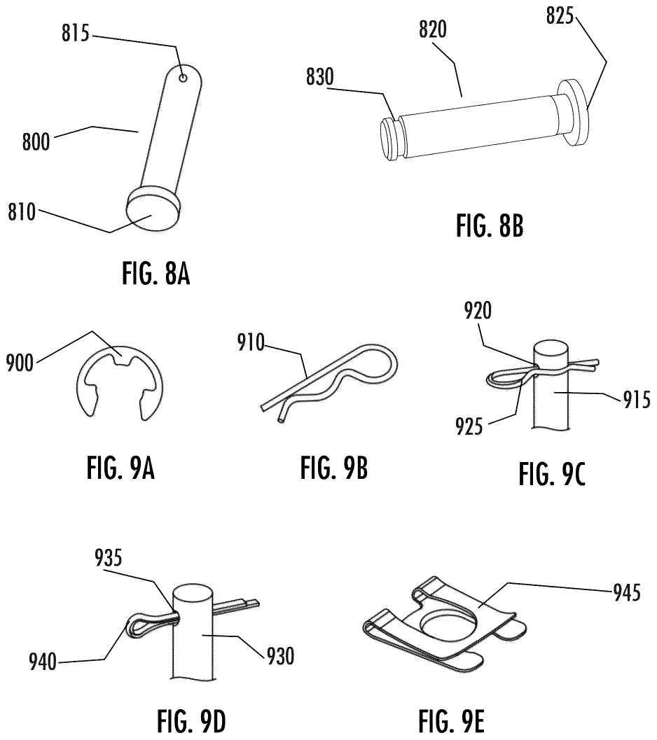

FIG. 8A shows retaining pin 800 that may be used to connect the side plates and rollers of the present hydraulic jack through their aligned central cylindrical apertures. One end of retaining pin 800 has first end 810 having a diameter larger than the diameter of the aperture through which is passes, while the other end has aperture 815 through which a retaining clip may be inserted.

FIG. 8B shows another embodiment 820 of a retaining pin. Retaining pin 820 similarly has one end 825 with a diameter larger than the diameter of the aperture through which it passes, while the other end has groove 830 to receive a retaining clip or spring retainer.

FIG. 9A shows a form of retaining clip, sometimes referred to as an e-clip, that may be used in combination with a retaining pin having a groove in one end to secure it in place. For example, retaining clip 900 may be pressed into place in groove 830 of retaining pin 825 after that retaining pin has been inserted as previously described through an aperture in a first side plate; a central cylindrical aperture of a roller aligned with that aperture; and an aperture in a second side plate aligned with both the central cylindrical aperture of the roller and the aperture of the first side plate.

FIG. 9B shows an alternative form of retaining clip 910, which may be referred to as a cotter pin. Cotter pin 910 may be used in combination with a retaining pin that has an aperture in one end, such as retaining pin 800 in FIG. 8A. For example, after retaining pin 800 has been inserted through an aperture in a first side plate, a central cylindrical aperture of a roller aligned with that aperture, and an aperture in a second side plate aligned with both the central cylindrical aperture of the roller and the aperture of the first side plate such that aperture 815 extends beyond the second side plate, cotter pin 910 may be inserted through aperture 815 to secure retaining pin 800 in place.

FIG. 9C is a detail showing one end of retaining pin 915 with aperture 920. Retaining clip or cotter pin 925 is inserted through aperture 920. Cotter pin 925 prevents retaining pin 915 from being dislocated such that it no longer securely connects the side plates and rollers through which it passes, yet may be removed when desired in order to service or disassemble a track assembly.

Similarly, FIG. 9D shows one end of retaining pin 930 with aperture 935. Retaining clip 940 is inserted through aperture 935. It can be seen that one end of retaining clip 940 forms a loop having a larger diameter than the diameter of aperture 935, which prevents the retaining clip from passing through the aperture. The opposite end of retaining clip 940 ends in two parallel, partially overlapping lengths, with one length being longer than, and so extending beyond, the other. This facilitates bending at least one of the lengths away from the other length to prevent retaining clip 940 from moving out of aperture 935 unless the lengths are bent back to a position where they are substantially parallel to aperture 935.

FIG. 9E shows another type of retaining clip 945, which may be referred to as a spring retainer. Spring retainer 945 may be used with a retaining pin of the type shown in FIG. 8B. When groove 830 of retaining pin 820 has been inserted through an aperture in a first side plate, a central cylindrical aperture of a roller aligned with that aperture, and an aperture in a second side plate aligned with both the central cylindrical aperture of the roller and the aperture of the first side plate such that groove 830 extends beyond the second side plate, spring retainer 945 may be inserted into groove 830 to prevent retaining pin 820 from being dislocated such that it no longer securely connects the side plates and rollers through which it passes, yet may be removed when desired in order to service or disassemble a track assembly.

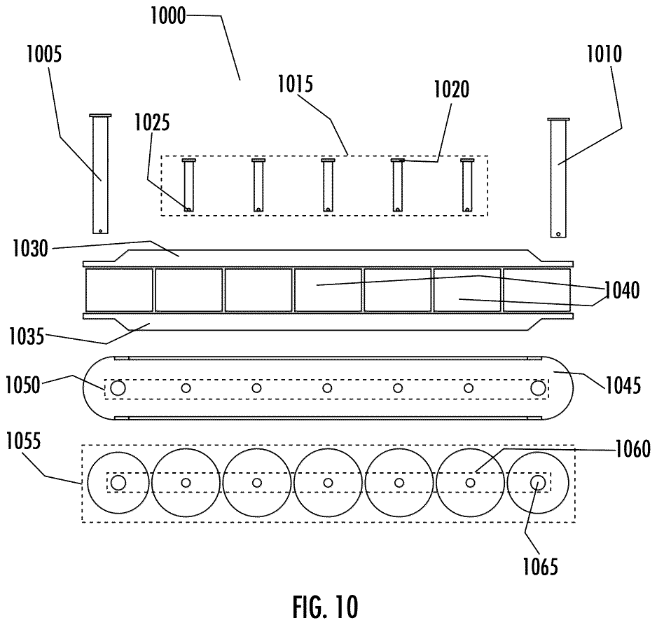

FIG. 10 shows another embodiment 1000 of the present track assembly. At the top of FIG. 10 are a series of axle pins. On either end are first axle pin 1005 and second axle pin 1010, each having a length greater than that of the intermediate axle pins 1015 because they will help secure the track assembly to frame assembly 600 (see FIG. 6). With further reference to FIG. 6, first axle pin 1005 and second axle pin 1010 will each pass through an end roller such as end roller 680; a side plate of the track assembly; another side plate of the track assembly; a vertical wall of the frame assembly; and then, in reverse order on the other side of the frame assembly, through a vertical wall of the frame assembly; a side plate of the track assembly; another side plate of the track assembly; and another end roller. It should be noted that the end rollers may be located outside the outer side plate of each track assembly as shown in FIG. 6; and/or, may be located between the outer side plate and inner side plate of each track assembly similar to the location of the intermediate rollers.

A plurality of retaining pins 1015 are located between first axle pin 1005 and second axle pin 1010. While five retaining pins are shown in FIG. 10, any suitable number may be used. The plurality of retaining pins 1015 each have a first end 1020 with a diameter larger than the diameter of the aperture through which the pins are inserted to provide an end or stop point when the retaining pin is inserted through a side plate of the track assembly, and a second end 1025 adapted to accept a retaining clip to maintain the retaining pins in place when fully inserted. In FIG. 10, second end 1025 is shown as an aperture but, as previously discussed, a groove may also be used.

Moving from the top towards the bottom of FIG. 10, below the retaining pins are shown first or inner side plate 1030, second or outer side plate 1035, and a plurality of rollers 1040 located between the inner and outer side plates.

Next is shown a side view of side plate 1045, including first plurality of apertures 1050. As shown herein and previously discussed, the aperture at either end may be larger than the intermediate apertures in order to accommodate an axle pin having a larger diameter than the retaining pins.

The bottom of FIG. 10 shows a plurality of rollers 1055 having a corresponding plurality of cylindrical central apertures 1060. Aperture 1065 for one end roller (the right-most roller in the view of FIG. 10), and the corresponding aperture at the other end roller (the left-most roller in the view of FIG. 10), may have a larger diameter than the intermediate apertures in order to accommodate the axle pins.

While the apparatus of the present application has been described with reference to particular embodiments, it will be understood by those skilled in the art that various changes may be made and equivalents may be substituted for elements thereof without departing from the intended scope. In addition, many modifications may be made to adapt a particular situation or material to these teachings without departing from the intended scope.

In particular, but without limitation, the particular dimensions of the present frame assembly, including the length, width, and height of its parts; the diameters and thicknesses of the rollers; the diameters and lengths of the retaining pins; and the number and distribution of the rollers and retaining pins, may be varied by those of ordinary skill in the art based on the present teachings without departing from the scope of the appended claims. Similarly, while particular types of retaining pins and retaining clips have been shown and described in this application, any type of retaining pin and clip providing the same or substantially the same function may be used Therefore, it is intended that the scope not be limited to the particular embodiments disclosed herein, but rather will include all embodiments falling within the scope and spirit of the appended claims.

What I/We claim is:

1. A hydraulic jack comprising:
a) a frame having a first side, a second side, a front end, a back end, a width, and a length;
b) a lifting arm;
c) a hydraulic pump;
d) a handle;
e) a first track assembly attached to said first side and a second track assembly attached to said second side,
f) each of said first track assembly and said second track assembly extending along substantially the entire length of said frame and comprising:
i. a first side plate adjacent said frame having a first plurality of cylindrical apertures spaced horizontally along its length,
ii. a second side plate opposite said first side plate having a second plurality of cylindrical apertures spaced horizontally along its length,
iii. a plurality of rollers spaced along the track assembly between said first side plate and said second side plate, each of said plurality of rollers having a central cylindrical aperture,
wherein each of said first plurality of cylindrical apertures along said first side plate, each said central cylindrical aperture in each of said plurality of rollers, and each of said second plurality of cylindrical apertures along said second side plate, are aligned to form a continuous aperture extending through said first side plate, each of said plurality of rollers, and said second side plate; and,
g) a plurality of retaining pins inserted through each said continuous aperture, each retaining pin having a first end larger in diameter than at least one of said first plurality of cylindrical apertures and said second plurality of cylindrical apertures, and a second end having a circumferential groove or aperture to receive a retaining clip to retain said retaining pin within said continuous aperture.

2. The hydraulic jack of claim 1 wherein said plurality of rollers extends along substantially the entire length of said first side plate and said second side plate.

3. The hydraulic jack of claim 1 wherein said first track assembly and said second track assembly are interchangeable.

4. The hydraulic jack of claim 2 wherein each track assembly has a length approximately equal to the length of said frame and each of said plurality of rollers has a diameter of between about 2 inches and about 3 inches.

5. The hydraulic jack of claim 4 wherein at least one of said plurality of rollers has a diameter of between about 2.25 inches and about 2.75 inches.

6. The hydraulic jack of claim 3 wherein the roller in said first track assembly and in said second track assembly that is closest to the front end of said frame has a diameter of between about 5% and about 15% smaller than the diameter of the other rollers in the track assembly, further wherein the tops of all rollers are coplanar.

7. The hydraulic jack of claim 6 wherein the roller in said first track assembly and in said second track assembly that is closest to the front end of said frame has a diameter of about 2.5 inches, and the other rollers in the track assembly each have a diameter of about 2.75 inches.

8. A hydraulic jack comprising:
a) a frame having a first side, a second side, a front end, a back end, a width, and a length;
b) a lifting arm;
c) a hydraulic pump;
d) a handle;
e) a first track assembly attached to said first side and a second track assembly attached to said second side,
f) each of said first track assembly and said second track assembly extending along substantially the entire length of said frame and comprising:
i. a first side plate adjacent said frame having a first plurality of cylindrical apertures spaced horizontally along its length,
ii. a second side plate opposite said first side plate having a second plurality of cylindrical apertures spaced horizontally along its length,
iii. a plurality of rollers spaced along the track assembly between said first side plate and said second side plate, each of said plurality of rollers having the same diameter and having a central cylindrical aperture,
wherein each of said first plurality of cylindrical apertures along said first side plate, each said central cylindrical aperture in each of said plurality of rollers, and each of said second plurality of cylindrical apertures along said second side plate, are aligned to form a continuous aperture extending through said first side plate, each of said plurality of rollers, and said second side plate; and,
iv. a plurality of retaining pins inserted through each said continuous aperture, each retaining pin having a first end larger in diameter than at least one of said first plurality of cylindrical apertures and said second plurality of cylindrical apertures, and a second end having a circumferential groove or aperture to receive a retaining clip to retain said retaining pin within said continuous aperture; and,
g) a first continuous belt surrounding said plurality of rollers in said first track assembly and a second continuous belt surrounding said plurality of rollers in said second track assembly.

9. The hydraulic jack of claim 8 wherein said first continuous belt and said second continuous belt are made of a material comprising at least one of a fluoropolymer, an acetal polyoxymethylene resin, and a rubber.

10. The hydraulic jack of claim 9 wherein said first continuous belt and said second continuous belt are made of a material comprising a fluoropolymer and an acetal polyoxymethylene resin.

11. The hydraulic jack of claim 9 wherein said fluoropolymer is a polytetrafluoroethylene.

12. The hydraulic jack of claim 8 wherein said plurality of rollers extends along substantially the entire length of said first side plate and said second side plate.

13. The hydraulic jack of claim 12 wherein each track assembly has a length approximately equal to the length of said frame, and each of said plurality of rollers has a diameter of between about 2 inches and about 3 inches.

14. The hydraulic jack of claim 13 wherein at least one of said plurality of rollers has a diameter of between about 2.25 inches and about 2.75 inches.

15. The hydraulic jack of claim 8 wherein the roller in said first track assembly and in said second track assembly that is closest to the front end of said frame has a diameter of between about 5% and about 15% smaller than the diameter of the other rollers in the track assembly, further wherein the tops of all rollers are coplanar.

16. The hydraulic jack of claim 15 wherein the roller in said first track assembly and in said second track assembly that is closest to the front end of said frame has a diameter of about 2.5 inches, and the other rollers in the track assembly each have a diameter of about 2.75 inches.

17. A track assembly for a hydraulic jack having a frame with a first side, a second side, and a length, said track assembly comprising:
a) a first side plate having a first plurality of cylindrical apertures spaced horizontally along its length,
b) a second side plate having a second plurality of cylindrical apertures spaced horizontally along its length,
c) a plurality of rollers spaced along the track assembly between said first side plate and said second side plate, each of said plurality of rollers having the same diameter and having a central cylindrical aperture, wherein each of said first plurality of cylindrical apertures along said first side plate, each said central cylindrical aperture in each of said plurality of rollers, and each of said second plurality of cylindrical apertures along said second side plate, are aligned to form a continuous aperture extending through said first side plate, each of said plurality of rollers, and said second side plate; and
d) a plurality of retaining pins inserted through each said continuous aperture, each retaining pin having a first end larger in diameter than at least one of said first plurality of cylindrical apertures and said second plurality of cylindrical apertures, and a second end having a circumferential groove or aperture to receive a retaining clip to retain said retaining pin within said continuous aperture.

18. The track assembly of claim 17 wherein one of said plurality of rollers that is not positioned between two other rollers has a diameter between about 5% and about 15% smaller than the diameter of the other rollers, further wherein the tops of all rollers are coplanar.

19. The track assembly of claim 18 wherein the roller having a diameter between about 5% and about 15% smaller than the diameter of the other rollers in the track assembly has a diameter of between about 2.25 inches and about 2.75 inches.

20. The track assembly of claim 17 comprising a continuous belt surrounding said plurality of rollers in said track assembly, further wherein said continuous belt is made of a material comprising at least one of a fluoropolymer, an acetal polyoxymethylene resin, and a rubber.
